(19) United States
(12) Patent Application Publication
(10) Pub. No.: US 2024/0393959 A1
(43) Pub. Date: Nov. 28, 2024

(54) MEMORY MANAGEMENT METHOD FOR PSEUDO-FUNCTIONAL DIFFERENTIABLE PROGRAMMING

(71) Applicant: Purdue Research Foundation, West Lafayette, IN (US)

(72) Inventors: Jeffrey M. Siskind, West Lafayette, IN (US); Hamad Ahmed, West Lafayette, IN (US)

(73) Assignee: Purdue Research Foundation, West Lafayette, IN (US)

(21) Appl. No.: 18/689,861

(22) PCT Filed: Dec. 23, 2021
(86) PCT No.: PCT/US21/65145

§ 371 Date: Mar. 6, 2024

Related U.S. Application Data
(60) Provisional application No. 63/242,963, filed on Sep. 10, 2021.

(51) Int. Cl. G06F 3/06

(52) U.S. Cl. CPC G06F 3/0619; G06F 3/0647; G06F 3/0685

(57) ABSTRACT

A computer-implemented method of operating on a program is disclosed which includes executing at least one instruction towards method of operating a program, the execution includes receiving request for input data associated with at least one dataset; at run time determining if the input data associated with the at least one dataset is resident on memory of one or more processors of a second class (Class2 Processors), if the associated data is resident on the memory of at least one or more processors of a first class (Class2 Processors) and not resident on the memory of the Class2 Processors, i) retrieving only the associated input data from the memory of the Classi Processors, ii) copying the associated input data onto the memory of the Class2 Processors, iii) using the retrieved input data in the execution of the at last one instruction, and iv) generating output data.

### CROSS-REFERENCE TO RELATED APPLICATIONS

The present patent application is related to and claims the priority benefit of U.S. Provisional Patent Application Ser. No. 63/242,963 filed Sep. 10, 2021, the contents of which are hereby incorporated by reference in its entirety into the present disclosure.

### STATEMENT REGARDING GOVERNMENT SUPPORT

This invention was made with government support under 1522954 IIS and 1734938 IIS awarded by the National Science Foundation; and under D17PC00341 awarded by the Intelligence Advanced Research Projects Activity. The government has certain rights in the invention.

### TECHNICAL FIELD

The present disclosure generally relates to functional programming, and in particular to memory management arrangements for these functional programming including functional differentiable programming, and further including structured networks.

### BACKGROUND

This section introduces aspects that may help facilitate a better understanding of the disclosure. Accordingly, these statements are to be read in this light and are not to be understood as admissions about what is or is not prior art.

General functional programming on GPUs including functional differentiable programming carried out on GPUs and further structured networks including neural Networks and other structured networks have been used as part of machine learning and artificial intelligence for several decades, going back to early part of 1940s as introduced by Warren McCulloch and Walter Pitts. A structured or a layered network such as a neural network may include a number of layers, each layer comprising of a large number of nodes (called neurons in the case of a neural network). These layers and their nodes are interconnected with other layers and their respective nodes, but more generally in arbitrary functional programs, these are referred to as intermediate variables. Each node is represented by a number often called activation, and more generally in arbitrary models written as functional programs, these are referred to as intermediate values. The connection between any two nodes is represented by another number often called weights. It should be noted that in general programs, the weights are referred to as parameters.

In order to establish the weights a process often called the learning process is carried out—and more generally with models written as arbitrary functional programs, learning establishes the parameters referred to above—and then to apply these weights to an input dataset in order to generate an output of the network (or alternatively individual samples are used to generate the output), a computer uses one or more central processing units (CPUs) and one or more graphics processing units (GPUs). In today's technology, however, a CPU is capable of having a much larger amount of memory as compared to a GPU. Thus in many cases, data is held in a CPU and the GPU waits idle until the data is fetched from the CPU, resulting in a poor-efficiency processing.

This efficiency problem is further exasperated by the fact that neural networks and other structured networks are getting deeper. For example, in 2012 a typical complex network had 23 layers, in 2105 43 layers, in 2015 147 layers, in 2016 464 layers, and in 2017 606 layers. Other reports indicate even deeper networks. For example in one instance in 2016 and 2017 1001 and 1202 layers were reported, respectively. More generally, models are becoming larger and more complex, resulting in longer runtime requiring memory with size that is proportional to the runtime of the model. Specifically, deep network depth is only a special case of models that require longer to run and thus have more intermediate variables that require to be stored when taking the gradient of the model.

These deep layers place a significant burden on GPUs. For example, a single NVIDIA GTX 580 GPU has only 3 GB of memory, which limits the maximum size of the networks that can be trained on it. However, even with improvements provided to date where data is to be fetched from the other GPUs or one or more CPUs and/or main memory, a GPU may end up waiting, thus resulting in a less efficient process.

Specifically, such structured networks use the vast majority of memory for one of two purposes. Backpropagation requires storing the intermediate values of the network, i.e., the activations, during the forward sweep for use during the reverse sweep. As networks get deeper, there are more intermediate values. Beyond this, as networks get deeper they tend to have larger model order, i.e., numbers of parameters or weights, not only because they get deeper but also because they get wider. Optimal performance of the network can be reached by balancing the number of filters per stage and the depth of the network. Increasing both the width and the depth of the network can contribute to higher quality networks. However, the optimal improvement for a constant amount of computation can be reached if both are increased in parallel. The computational budget should therefore be distributed in a balanced way between the depth and width of the network.

Additionally, neural networks are being deployed with higher model order. For example, a typical neural network in 2012 had between 60 and 144 million parameters, in 2019 had between 340 million parameters and 1.5 billion. These large sets of parameters further exasperates the memory usage and results in even a lower efficiency.

Therefore, there is an unmet need for a novel approach to manage memory usage between CPUs, GPUs, and main memory to alleviate inefficiencies that exist in today's differentiable programming.

### SUMMARY

A computer-implemented method of operating on a program is disclosed. The method includes executing at least one instruction towards method of operating a program. The execution of the at least one instruction includes receiving request for input data associated with at least one dataset, at run time determining if the input data associated with the at least one dataset is resident on memory of one or more processors of a second class. If the associated input data is resident on the memory of the at least one or more processors of a second class then the method includes i) retrieving only the associated input data from the memory of the at least one or more processors of a second class, ii) using the retrieved input data in the execution of the at last one instruction, and iii) generating output data associated with the at least one dataset. If the associated input data is not resident on the memory of the at least one or more processors of a second class, then the method includes determining if the input data associated with the at least one dataset is resident on memory of one or more processors of a first class. If the associated data is resident on the memory of the at least one or more processors of a first class and not resident on the memory of the at least one or more processors of a second class, then the method includes i) retrieving only the associated input data from the memory of the at least one or more processors of a first class, ii) copying the associated input data from the memory of the one or more processors of a first class onto the memory of the at least one or more processors of a second class, iii) using the retrieved input data in the execution of the at last one instruction, and iv) generating output data associated with the at least one dataset.

According to one embodiment, performing a copying or writing operation to the memory of the one or more processors of a second class, includes determining if there is sufficient contiguous memory available in the one or more processors of a second class. If there is sufficient contiguous memory, then the method includes performing the copying or writing operation to the memory of the one or more processors of a second class. If there is not sufficient contiguous memory, then the method includes calling a garbage collector adapted to remove unneeded data in the memories of the one or more processors of a second class.

According to one embodiment, further comprising determining if there is still insufficient contiguous memory in the memories of the one or more processors of a second class, then compacting data in the memories of the one or more processors of a second class.

According to one embodiment, further comprising determining if there is still insufficient contiguous memory in the memories of the one or more processors of a second class, then removing least recently used data in the memories of the one or more processors of a second class.

According to one embodiment, the method further includes determining if there is still insufficient contiguous memory in the memories of the one or more processors of a second class, then halt execution of the at least one instruction and issuing an out-of-memory error.

According to one embodiment, the method further includes initially analyzing the program, and generating a streaming plan for usage of data associated with the one or more datasets, where the streaming plan includes when input data associated with the at least one datasets is needed.

According to one embodiment, the streaming plan is further based on when output data associate with the at least one datasets is available for storage in memory of the at least one or more processors of a second class.

According to one embodiment, the step of analyzing the program includes performing a profile run at run time to determine structure the program.

According to one embodiment, the program is a functional differential program.

According to one embodiment, the functional differential program is a structured network.

According to one embodiment, the structured network is a neural network.

According to one embodiment, the streaming plan includes pre-fetching data for the memories of one or more processors of a second class based on a window of future cycles of the one or more processors of a second class.

According to one embodiment, size of the window is predefined.

According to one embodiment, size of the window is provided by a user.

According to one embodiment, size of the window is adaptive based on the out-of-memory errors.

According to one embodiment, the step of analyzing the program includes performing a static analysis at compiler stage to determine variable control flow of the program.

According to one embodiment, the static analysis is adaptive based on a speculative execution scheme.

According to one embodiment, the at least one dataset is a tensor.

According to one embodiment, the one or more processors of a second class includes coprocessors.

According to one embodiment, the coprocessors include graphics processing units.

According to one embodiment, the coprocessors include tensor processing units.

According to one embodiment, the one or more processors of a first class includes central processing units.

### BRIEF DESCRIPTION OF DRAWINGS

FIG. 1 is a program designed to implement RESNET in Scorch.

FIG. 2a is a graph of run time in seconds vs. number of Graphics processing units (as members of a second class of processors) comparing run time of the Scorch implementation of RESNET-152, with and without tensor streaming, with the PYTORCH implementation, for various numbers of GPUs.

FIG. 2b is a graph of run time in seconds vs. a base-case duration showing comparison of run time of the Scorch implementation, on a single GPU, with tensor streaming, for various depths and base-case durations.

FIG. 3 is graph of run time in seconds vs. depth of a network showing comparison of run time of the Scorch implementation, on a single GPU, with tensor streaming, for various depths, all with a base-case duration of 10,000.

FIG. 4 is a graph of run time in seconds vs. depth of a network, showing comparisons of run times with the implementation of tensor streaming with an alternate implementation based on NVIDIA's unified memory.

FIG. 5 is a program showing how a Generative Pre-trained Transformer (GPT) architecture was implemented in Scorch.

FIG. 6a is graph of run time in seconds vs. base-case duration which shows that the implementation according to the present methodology incurs little overhead in the interruption and resumption mechanism.

FIG. 6b is a graph of run time in seconds vs. n-params showing that the implementation according to the present disclosure scales slightly super-linearly with the number of parameters, which is related to network depth.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel approach is presented herein to manage memory usage between central processing units (CPUs), graphics processing units (GPUs), and main memory of a computer system to alleviate inefficiencies that exist in today's differentiable programming. As an initial matter, while a great deal of the present disclosure is directed to structured networks such as a neural network, no such limitation is intended. Specifically, the method of the present disclosure applies to any operation where data is held in CPU memory and is needed for GPU operation. Towards this end, the method of the present disclosure provides a just-in-time availability of data for GPUs from CPU memory, all carried out by an application programming interface (API) performed in a background process such that data needed by GPUs are already loaded onto the GPU memory prior to the data being needed by the GPUs. Towards this end, the method of the present disclosure employs two types of data migration: 1) demand fetch, which is based on fetching data from the CPU memory for copying on to GPU memory at any point in time, and 2) eager fetch which is based on fetching data that will be used/needed in one or more cycles of GPU operations. It should be noted that functional differentiable programming, a type of programming to which the present disclosure is particularly directed, does not mutate data in memory (CPU or GPU), thus the method of the present disclosure only provides copies of the data for the GPU memory from the CPU memory. As a result there is no contention whether the data in CPU memory has changed (mutated) or not. Furthermore, the data in CPU memory can reside in both CPU memory and in one or more GPU memories. Such a scheme is particularly important when multiple GPUs are used, where the prior art memory management (e.g., NVIDIA uniform memory) is incapable of handling. This advantage is brought on, because no synchronization of data is needed between the different places data is held.

In addition to functional differentiable programming, the method of the present disclosure can also be applied to a pseudo-functional differentiable programming, whereby data at a specific point can be written to CPU memory (i.e., mutation of data in the CPU memory). In a structured network as a first type of a differentiable program, such as a neural network, this mutation can occur after a complete cycle of the network, whereby weights that are usually held in the CPU memory are to be updated with data calculated in the one or more GPUs. It should be noted that this mutation is a special case of a more general situation that occurs not just with neural networks but with any machine learning model written as a functional differentiable program. In any model written as a functional differentiable program optimized based on gradient descent, a weight/parameter update step once per iteration is required which involves a mutation but all other computations do not. As discussed in much greater detail below, *J-update! is a primitive in the API of the method of the present disclosure that can be used to update data in the CPU memory based on the following construct: 1. There is a single copy of the parameters on the CPU. 2. An update step begins. 3. When computing the objective function and/or its gradient, the parameters might be copied to one or more GPUs one or more times. 4. When the computation of the objective function and its gradient are completed, *j-update! updates the copy of the parameters on the CPU. 5. The next update step will cause the parameters to be transferred from the CPU to the GPUs again. Thus, weights/parameters are not retained in the GPUs across iterations.

Referring back to the two types of fetching, In the case of eager fetching, initially, an analysis of the structure of the program is ascertained. This structure analysis can be performed by 1) a profiling run performed at run time by the method of the present disclosure of the differentiable program to determine the structure of the program. In any functional program that does not have varying control flow, structured networks just being a special case of that, and neural networks being a special case of structured networks, the structure of the network can be ascertained with accuracy utilizing the profiling run. In this case, the data associated with the structured network is identified ahead of time and that data is migrated from the CPU memory to the GPU memory utilizing the API of the present methodology completely in the background process. In the case where the differentiable program is not of a structured network variety but includes a plurality of variable control flow, for example due to a plurality of if-then-else statements, then the analysis includes a profiling run. A profiling run can be carried out even in the presence of control flow, resulting in profiling of only one control flow. When the actual control flow executed and the flow is the same as the control flow during the profiling run, the eager fetching plan is considered to have been successful. However, if there is a differing control flow, then the eager fetching will be insufficient. In those cases a demand fetch. Thus, the amount of demand fetch required depends on how much the actual control flow deviates from the profiled control flow. Alternatively, a static analysis of the differentiable program is carried out to determine all the possible variable control flows. Once that is known, the API of the present methodology applies the eager fetch based on the static analysis. Regardless of which kind of differentiable program is of concern, the method is applied to a streaming plan thus is generated based on this analysis. The streaming plan in the case of a structured network, e.g., a neural network, is substantially constant. However, the streaming plan in the case of a differentiable program without a structured network, can be adaptive, using a speculative execution process, known to a person having ordinary skill in the art. By adaptive it is meant the streaming plan can change dynamically once it is determined that the streaming plan utilizing speculative execution resulted in error. The error is used to generate a feedback signal for the streaming plan to modify the stream plan towards minimizing errors between the speculative and actual execution variable control flow. The notion of eager fetching is based on the fixed streaming plan that includes a list of tenors in the order they will be accessed. These tensors are eagerly copied to the GPUs. Since there is a fixed size memory buffer, the tensors are eagerly copied until that buffer is full. Once tensors in that buffer are finished being accessed they are flushed. That allows more tensors to be eagerly copied. This type of data fetching results in a much higher efficiency for the GPUs which would otherwise spend an inordinate amount of time waiting for data to be copied from the CPU to the GPU. The tradeoffs (i.e., control knobs) include limiting the number of prefetched tensors. Another way is to limit the amount of memory in the buffer that stores prefetched tensors.

Thus, the size of the window by which eager fetching is carried out can be either a set size either defined by a user, or provided as a predetermined number. Alternatively the size of the window may be adaptive based on when a GPU runs out of memory due to too large of a window. To alleviate the situation with which the GPU has issues with memory size of tensors that require the tensor to be copied as contiguous data in GPU memory, the API in a background process, performs a garbage collector function whereby it performs the following steps in the order specified: 1) identifies data which data previously copied from the CPU memory into GPU memory that is no longer needed and frees the GPU memory to make room for the data it had planned to copy from the CPU; 2) performs data compaction, known to a person having ordinary skill in the art, 3) discards least recently used data in the GPU memory, and 4) if none of the above steps are viable, halts execution and provides an error message of out of memory. According to one embodiment of the present disclosure, when the garbage collector function is called, the window is adaptively adjusted in order to prevent the calling of the garbage collector function in the next iteration of the differentiable program. The out of memory error is used as a feedback signal to modify the window size for the next iteration.

It should also be noted that not only does the methodology of the present disclosure advantageously provides added efficiency afforded by the API running data copying as a background process, but the present methodology is adapted to provide data copying in necessary proportions of tensors rather than whole pages of data as is the case with the current prior art schemes. In other words, the current methodology affords the added efficiency by recognizing the need in the GPU for a particular snippet of a tensor (e.g., a row, a column, a plurality of rows, etc.) and copying only that portion of the tensor from the CPU memory to the GPU memory. In contrast, current prior art technologies, e.g., the unified memory methodology of NVIDIA, is configured to transfer a page at a time, even if the majority of data is not needed in the transferred page. The approach of the method of the present disclosure is particularly advantageous when the tensor data is spread across several pages in a non-contiguous manner. In that case, according to the uniform methodology of the prior art, e.g., NVIDIA, each one of the pages holding part of the tensor data has to be copied in order to reconstruct the tensor data needed in contiguous memory in the one or more GPUs. However, loading of each page is associated with an overhead. In contrast, the method of the present disclosure, brings in data from the CPU memory according to a background process all at once based on location of the data in the CPU memory, thereby doing away with the overhead of loading each page, or the overhead associated with bringing in data that is not related to tensor only because that data happened to be in the same page as the other tensor data.

In order to demonstrate the method of the present disclosure, a structured network in the form of a neural network is assumed as the differentiable program, however, as indicated above, no such limitation is assumed by way of this example.

Two approaches for improving memory usage have been investigated by the authors of the present disclosure including i) divide and conquer checkpointing which is the subject of a U.S. Pat. App. Ser. No. 16/336,094 published as US. Pub. No. 2019-0235868, incorporated by reference in its entirety into the present disclosure, and ii) tensor streaming which is the subject of the present disclosure. The tensor streaming performs just-in-time migration of data back and forth between the CPU and GPU in parallel to GPU computation. This methodology allows CPU memory to serve as a sort of virtual memory for the GPU RAM. While the largest currently available GPUs have 80 GB of RAM, current CPUs can contain as much as 8 TB of RAM in a single node, providing a substantial advantage by way of the method of the present disclosure.

To implement the tensor streaming methodology, a system referred to herein as the Scorch was developed. Scorch is a dialect of SCHEME, known to a person having ordinary skill in the art, that has support for GPU computation based, in part, on the TORCH LIBRARY. Almost all deep-learning frameworks, such as TORCH, CAFFE, MXNET, CHAINER, TENSORFLOW, THEANO, DARKNET, and PYTORCH, all known to a person having ordinary skill in the art, implement backpropagation either in a limited domain-specific language or embedded in an existing programming-language implementation through a foreign-function interface. The tensor streaming techniques, particularly when generalized to support not only deep neural networks but also arbitrary differentiable programming, cannot be implemented in such a fashion because these techniques require specialized low-level support from the programming-language implementation and run-time system. Thus, Scorch is not based on any existing SCHEME implementation but rather on a custom implementation that provides the requisite low-level support.

Most recent publications on differentiable programming within the POPL, PLDI, and ICFP communities either do not come with any implementation at all, or if they do, only come with one that does not run on GPUs or is incapable of running real-world deep-learning applications at competitive speeds. In contrast, the implementation according to the present disclosure has sufficient functionality that it can run real-world computer-vision applications such as RESNET, known to a person having ordinary skill in the art for image classification and DRANet for semantic segmentation, real-world natural-language processing applications such as the Generative Pre-trained Transformer-3 (GPT-3) transformer language model, also known to a person having ordinary skill in the art.

Scorch can run RESNET-152 with a network of the same depth and model order as the corresponding PYTORCH implementation almost as fast as PYTORCH. But it can also run variants of this network with three orders of magnitude greater depth and model order, something that neither PYTORCH nor any other current system can do, and do so with essentially the same speed relative to the size of the network as the smaller network. As discussed further below, Scorch supports running on a single GPU, multiple GPUs per node, and multiple nodes with multiple GPUs, using INFINIBAND for connection between nodes.

While there has been considerable recent work on tensor streaming, the methodology presented herein differs from the prior art publications in several keyways. First unlike all recent work, the present methodology supports tensor streaming for arbitrary differentiable programs performing tensor and GPU computation. Specifically, the known prior works carry out static analysis to precompute a streaming plan, and none does profile-based construction of a streaming plan combining eager fetch with demand fetch. Second, the present methodology supports both divide-and-conquer checkpointing and tensor streaming in a synergistic fashion with optimizations that are only possible when these techniques are combined. While divide-and-conquer checkpointing and tensor streaming are orthogonal to one-another, their combined implementation provides a substantial improvement over implementing one or the other method alone.

Scorch supports tensors of a variety of types: byte, char, short, int, long, float, and double that can reside on either the CPU or GPU. In the design of TORCH and PYTORCH, the residence of a tensor is coupled to where it is manipulated. CPU tensors both reside on the CPU and are manipulated on the CPU. GPU tensors both reside on the GPU and are manipulated on the GPU. Here a new class of tensors is introduced that is called streaming tensors. Streaming tensors include each of the above types of tensors. Streaming tensors decouple the residence from manipulation of a tensor. They are always manipulated on the GPU, but they can reside either on the CPU, GPU, or both. When GPU RAM is scarce, streaming tensors can be migrated from the GPU to the CPU. And when they need to be manipulated, they are copied to the GPU if they are not currently resident on the GPU.

While this type of manipulation of memory is reminiscent of virtual memory, no hardware or operating system support such as memory management units (MMUs) or page faults are used. This copying is managed in software. In that sense, the present disclosure provides a methodology that improves a technical solution to a practical problem. Furthermore, the methodology according to the present disclosure includes an API that depending on mode settings can avail itself of CUDA unified memory including without prefetching or with prefetching, and without unified memory altogether, thus advantageously allowing copying to be tightly coupled to the memory allocation and reclamation process on both the CPU and the GPU. It is also advantageous to carry out copying opportunistically based on metered program memory-access behavior. If the program accesses a streaming tensor and it is not resident on the GPU, the program pauses while it is copied to the GPU. The process of allocating GPU RAM for GPU tensors and streaming tensors that are the result of operations can cause unused streaming tensors to be migrated to the CPU in a least-recently-used fashion. This leads to the following policy for streaming tensors: 1) Each streaming tensor can reside on either the CPU or the GPU, and possibly both; 2) Whenever a primitive needs to access a streaming tensor, if it is resident on the GPU, the operation proceeds with the GPU copy; 3) Whenever a primitive needs to access a streaming tensor, if it is not resident on the GPU, the operation pauses while a copy is made from the CPU to the GPU. This process requires GPU memory to be allocated to hold the GPU copy of the streaming tensor. The streaming tensor then becomes resident on both the CPU and the GPU; 4) Whenever a primitive needs to produce a streaming tensor, it allocates memory on the GPU to hold the GPU copy of the streaming tensor. When it is finished producing the GPU copy, it schedules making a copy of the data from the GPU to the CPU in a separate background thread so that it does not need to pause. When that background thread completes the copy, the streaming tensor resides both on the CPU and the GPU; 5) Whenever GPU RAM must be allocated, either for creating a new GPU tensor, creating a new streaming tensor, or for copying a streaming tensor from the CPU to the GPU to allow access, the following process is performed: a) If there is sufficient contiguous GPU RAM available, the GPU copy is allocated, and execution proceeds, b) If not, a garbage collector is called to find dead GPU and streaming tensors that can be freed, c) If there now is sufficient contiguous GPU RAM available, the GPU copy is allocated, and execution proceeds, d) If not, and there is sufficient total GPU RAM available, GPU RAM compaction is performed, the GPU copy is allocated, and execution proceeds, e) If not, streaming tensors that reside both on the CPU and the GPU are evicted one by one in a least recently used fashion, marking them as residing only on the CPU, until sufficient total GPU RAM is available. If necessary, GPU RAM compaction is performed. The GPU copy is allocated, and execution proceeds. And f) If not, issue an out-of-memory error.

The above policy alone does not make optimal use of available resources. Situations can arise where programs pause to copy streaming tensors from the CPU to the GPU or migrate streaming tensors from the GPU to the CPU. To reduce these pauses, we introduce opportunistic copying and migration in the form of a streaming plan. We introduce a new primitive called get-streaming-plan: get-streaming-plan(f, x)|→p Return a streaming plan p, a list of all streaming tensors accessed while computing f(x), in the order they were accessed.

The get-streaming-plan takes a procedure f and argument x, and evaluates f(x), for the purpose of returning a streaming plan. This streaming plan is simply a Scorch list of streaming tensors.

Thereafter, another primitive is called: call-with-streaming-plan(p, f, x)|→f(x), that is f(x) is evaluated while running a background thread to opportunistically copy the non-GPU-resident streaming tensors in the streaming plan p, in order, from the CPU to the GPU. This background thread applies the following policy to each streaming tensor in the streaming plan in the following order: 1) If the streaming tensor is resident on the GPU, then do nothing; 2) If not, and there is sufficient contiguous GPU RAM available, allocate it, and copy the streaming tensor from the CPU to the GPU. The streaming tensor is now resident on both the CPU and the GPU; and 3) If not, then pause. Continue with the previous step when sufficient contiguous GPU RAM is available.

Crucially, this background thread does not perform any GPU RAM compaction, garbage collection, eviction, or copying from the GPU to the CPU. It thus never frees GPU RAM. This is to avoid any need to synchronize these operations between the foreground and background threads. It should be noted that any streaming tensor that is in the streaming plan and not yet processed by the background thread must still be live and thus will never be garbage collected. Thus, only the following need to be guaranteed: 1) Determination of the amount of contiguous and total GPU RAM available, allocation of that GPU RAM, and freeing of GPU RAM must be atomic; 2) The foreground thread cannot evict the GPU copy of a streaming tensor until the background thread has marked it as resident on the GPU; and 3) The foreground thread and the background thread must not both attempt to copy a streaming tensor from the CPU to the GPU. The foreground thread must inform the background thread that is has initiated a copy so that the background thread can avoid making a second copy and proceed with the next streaming tensor in the streaming plan. The background thread must inform the foreground thread that it has initiated a copy so that the foreground thread can avoid making a second copy. The foreground thread must pause until the background thread completes the copy.

Beyond the above, the method of the present disclosure ascertains that the background thread is not too eager. It opportunistically copies streaming tensors from the CPU to the GPU and thus can fill up GPU RAM. This copying can force the foreground thread to evict the GPU copies of streaming tensors in the streaming plan when it needs to allocate other GPU or streaming tensors, or needs itself to copy a streaming tensor to the GPU. To avoid this situation, a global parameter is utilized that limits how eager the background thread should be. That parameter indicates the maximum number of streaming tensors it should copy in advance from the CPU to the GPU. The background thread counts the number of previously copied streaming tensors in the portion of the streaming plan that it has already processed that are still resident on the GPU and pauses when the maximum number of advance copies has been reached. It waits for the foreground process to evict a streaming tensor from the GPU, one that appears on the portion of the streaming plan that it has already processed, before continuing.

CUDA, known to a person having ordinary skill in the art, supports data migration between a CPU and a GPU using unified memory, a single address space that is accessible from any CPU and GPU in the system. The user allocates unified memory using a special-purpose function. Upon accessing this memory on any CPU or GPU, the CUDA driver automatically migrates the pages to the relevant device and makes them available for access. When a GPU runs low on memory, the CUDA driver migrates old pages back to the CPU to make room for new pages. Without any special-purpose user programming, the migration of memory pages is triggered by page faults, i.e., accessing the data on a device where it is not resident triggers a page fault, the driver halts program execution, migrates the data, and resumes execution. This can be made more efficient, to overlap data transfer with computation to maximize GPU utilization, by making calls to a special prefetch function to make the CUDA driver aware of future data access patterns.

These two paradigms are herein referred to as unified memory no-prefetching vs. prefetching. Unified memory behaves similar to tensor streaming, especially if get-streaming-plan is used to determine the memory access pattern of the program beforehand, making use of unified memory prefetch possible. Still, there are some differences which make tensor streaming more efficient than unified memory. Tensor streaming always keeps a copy of the tensor on the CPU. Thus data copied to the GPU can be evicted after the program is finished using it without having to copy it back to the CPU.

Since Scorch is a functional language (i.e., data is not mutated), any data copied to the GPU will not be changed and need not be copied back. Unified memory, on the other hand, migrates instead of copies, and has to copy data back to the CPU after processing. Experiments were carried out using tensor streaming, unified memory no-prefetching, and unified memory prefetching to compare their performance. Tensor streaming performs much better than both variants of unified memory. Note that both tensor streaming and unified memory have the propensity to fill up GPU RAM by not evicting used data until the memory is full and space is required to copy or migrate new data. This issue is circumvented by limiting the amount of GPU RAM available to these mechanisms. Tensor streaming makes sure that data copied to the GPU does not get evicted until it is used. Unified memory prefetching, on the other hand, can migrate pages back before they are used, to make room for new prefetched pages, which results in on-demand migration of old pages when the program tries to access them. Indeed the experiments showed that unified memory no-prefetching actually performed better than unified memory prefetching.

As known to a person having ordinary skill in the art, machine learning often iterates gradient-descent steps to update a model parameters θ. The gradient ∇_{θ}f(θ,x), denoted as \grave{θ}, can be computed with*j (or checkpoint-*j).

$$〈 l , {θ}^{`} 〉 = * j ( f , θ , 1 )$$

$$θ := θ - η {θ}^{`}$$

Where I=f(θ) is the loss. When the model order is high, the model parameters θ do not fit in GPU RAM. In this case, we use streaming tensors to hold the model parameters θ so that they reside on the CPU and are only copied to the GPU when needed during the computation of *j(f, θ, 1). Note that the model-parameter gradients \grave{θ} are the same size as the model parameters θ themselves. Thus they also cannot reside on the GPU and are also stored in streaming tensors. This follows automatically from the default policy whereby any result computed by applying a primitive, in whole or in part, to streaming tensors produces a streaming tensor, since gradients are computed, in part, by application of primitives to primals, which in this case include θ. It should be noted that when a primitive produces a streaming tensor, it creates it on the GPU, but schedules making a copy to the CPU in a background thread so that it can be evicted as soon as possible without unnecessarily pausing the foreground thread. Thus the model-parameter gradients \grave{θ} are automatically copied to the CPU soon after allocation, and are often evicted from the GPU by the time the update step θ: =θ−η\grave{θ} is performed. Further, memory pressure in the GPU RAM means that the model parameters θ themselves are likely to have been evicted by the time the update step is performed. Consequently, there are two choices: the update step on the CPU can be done or copy both the model parameters θ and their gradients \grave{θ} back to the GPU, perform the update step on the GPU, and copy the result back to the CPU. Both of these methods are inefficient: the former because the CPU takes longer to perform the update computation than the GPU and the latter because it incurs twice the communication cost.

To enable a more efficient solution, a new primitive is introduced that fuses the update step into the gradient computation

$$〈 l , {θ}^{`} 〉 = * j - update ( f , θ , {l}^{`} , η )$$

where θ′=θ−η\grave{θ}. Crucially, such fusion allows the gradient computation to be specialized so that the last step of the gradient computation is interleaved with the update step. Thus the last step of the gradient computation does not initiate copying the model-parameter gradients θ′ back to the CPU allowing their eviction, but rather copies the model parameters θ to the GPU, if needed, during the last step of the gradient computation. Since the model-parameter gradients θ′ are not exposed as output of this primitive, they become dead upon completion and can be evicted without copying to the CPU. The model-parameter gradients θ′ are never allocated explicitly as a tensor, streaming or otherwise, and only exist ephemerally as the internal intermediate values inside the *j-update primitive. This allows performing the update step on the GPU and alleviates the need to explicitly represent and transport the model-parameter gradients. Scorch provides a variant checkpoint-*j-update that fuses checkpoint-*j with the update step and further provides variants of both for a variety of different update steps.

Table 1 presents the main basis procedures that operate specifically on tensors. The standard unary basis procedures sqrt, exp, log, sin, cos, zero?, positive?, and negative? are extended pointwise to tensors and the standard binary basis procedures +, −, *, /, max, min, atan, =, <, >, <=, and >= are extended to apply to a tensor and a scalar, or a scalar and a tensor, or two tensors of the same type and dimensions, in a pointwise fashion. Many of these primitives are simple wrappers around standard functions from the TORCH library. While this set of tensor procedures is tiny compared with that in PYTORCH, it is sufficiently rich to allow implementing all of the examples discussed below.

Table 1. Main Scorch tensor primitives. (type) denotes one of the types of byte, char, short, int, long, float, or double. (floating type) denotes one of the types of float or double. (residence) denotes one of the residences CPU, GPU, or streaming.

Most Scorch basis procedures can take one or more tensors as input and yield a tensor as output. Tensors have a variety of types (byte, char, short, int, long, float, or double) and a variety of residences (CPU, GPU, or streaming). Scorch basis procedures generally require all input tensors to have the same type and residence, and produce output tensors of the same type and residence as the input tensors. They generally also allow a mix of GPU and streaming tensors as input, producing a GPU tensor as output. Primals and associated tangent or cotangent values are not specifically constrained to have the same type and residence. Any constraint between the

| | | |
|---|---|---|
| list−><residence>-<type>-tensor | fill-<residence>-<type> | <residence>-<type>-tensor? |
| <residence>-<type> | randn-<residence>-<floating type> | normal-<residence>-<floating type> |
| size | tensor−>list | view |
| transpose | narrow-tensor | expand-tensor |
| concat-tensors | dot | sumall |
| addmv | addmm | baddbmm |
| addr | resize | pad |
| crop | decimate | interpolate |
| interpolate-to-size | upsample-nearest | downsample-nearest |
| permute | ReLU | LeakyReLU |
| GeLU | sigmoid | convolve |
| transpose-convolve | batch-normalization-training | batch-normalization-test |
| initialize-batch-normalization | layer-normalization | convolve-add-tied |
| embedding | max-pool | average-pool |
| dropout | dropout-planewise | max-value |
| index-of-max | cross-entropy-loss | softmax |
| fused-scale-mask-softmax | | |

mutual types and residences of primals and their associated tangents and cotangents results from the fact that the Jacobian-column-vector-product and row-vector-Jacobian-product functions are implemented either as primitives or as compositions of other basis functions and the constraints follow from the properties of this implementation. However, we adopt a simple rule that improves performance in the standard use-case of machine-learning models: in the row-vector-Jacobian-products of primitives, if the input x is a streaming tensor then the input cotangent \grave{x} will be a streaming tensor, even though it might be computed from output cotangent \grave{γ} and other inputs x′ that are GPU tensors.

As discussed above, while divide-and-conquer checkpointing and tensor streaming are orthogonal to one another these approaches serve complementary purposes. Divide-and-conquer checkpointing reduces the memory requirement for the tape, which corresponds to neural-network activations. Tensor streaming reduces the GPU RAM requirement for model parameters, which correspond to the neural-network weights. According to one embodiment of the present disclosure, static methods can be used for constructing streaming plans based on a fixed program structure or neural-network architecture. Indeed, the access patterns of forward and reverse automatic differentiation (AD) are sufficiently simple that this could be done easily; forward AD accesses the model parameters in the same order for the primal and tangent computation, while reverse AD accesses the model parameters in the reverse order from the forward sweep during the reverse sweep. It should be noted that the design of the present methodology allows tensors to be copied on demand, without a streaming plan, or with an inaccurate one, which provide several advantages. First, it allows the plan to be constructed in the first place by running code when a plan is not yet available. Second, it allows the methodology of the present disclosure to operate correctly, albeit less efficiently, if one constructs a representative streaming plan for a specific control flow that induces a particular access pattern, but uses it when the dynamic control flow varies and induces different access patterns.

In order to evaluate the performance of the present methodology, several applications have been considered against four real-world examples. For each of these applications, a full-fledged implementation that support training, i.e., computation of gradients of the loss function and associated parameter updates is carried out. In addition, data loaders were implemented that support training on large real-world datasets. The applications discussed below are presented to demonstrate the feasibility of training extremely large variants of these widely-used models, purely from the perspective of fitting these models into GPU RAM.

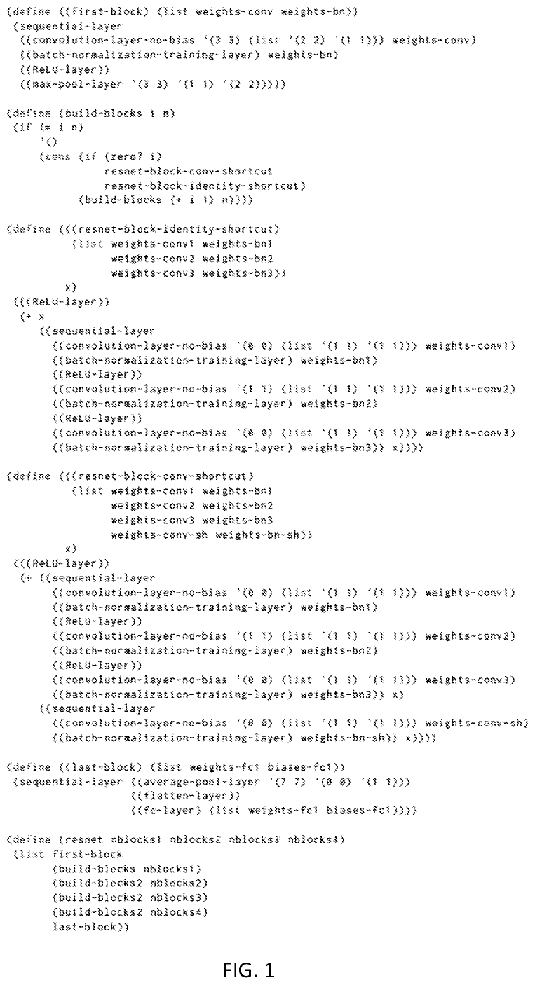

The first application to demonstrate the feasibility of the present methodology is image classification. The first example is RESNET, known to a person having ordinary skill in the art, is one of the most prominent and highest performing deep-learning image-classification systems that is widely used in the computer-vision community. RESNET neural-network architecture is formulated as a cascade of various sorts of blocks whose input and output are tensors of the same size. This allows blocks of the same kind to be repeated by varying amounts to create shallower or deeper networks. The original RESNET work evaluated variants with 18, 20, 32, 34, 44, 50, 56, 101, 110, 152, and 1,202 layers. Here, RESNET is implemented in Scorch as shown in FIG. 1 where variants with 152, 302, 1,001, 1,502, 3,003, 5,000, 10,001, 20,000, 50,000, 100,001, 150,002, and 250,001 layers are evaluated simply by changing the hyperparameters nblocks1, nblocks2, nblocks3, and nblocks4, to demonstrate that Scorch allows training extremely deep neural networks, ones that would be impossible to train on any other existing system. The ability to train such extremely deep networks relies crucially on tensor streaming.

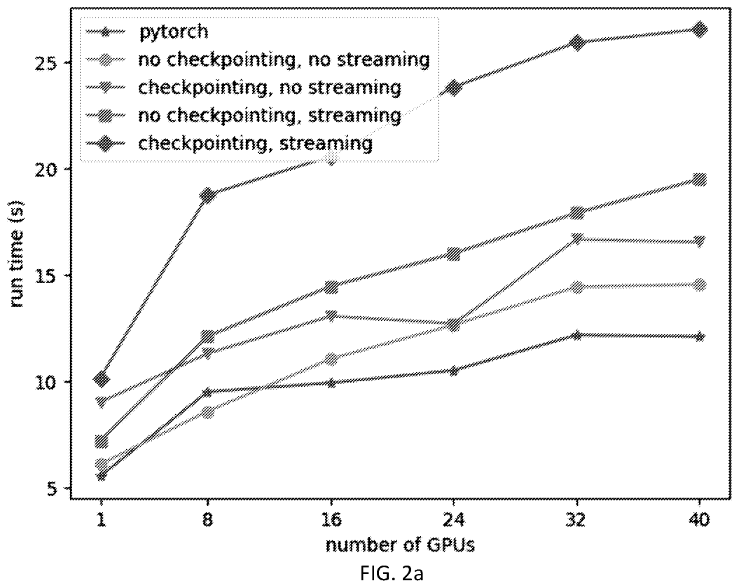

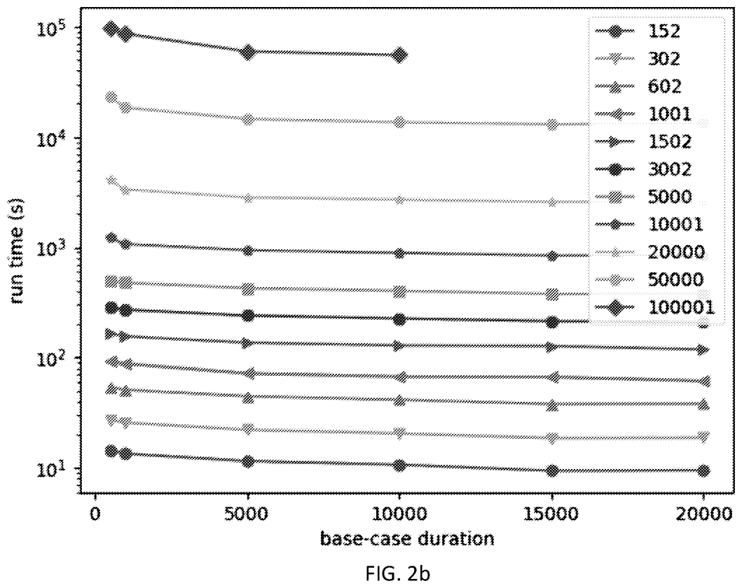

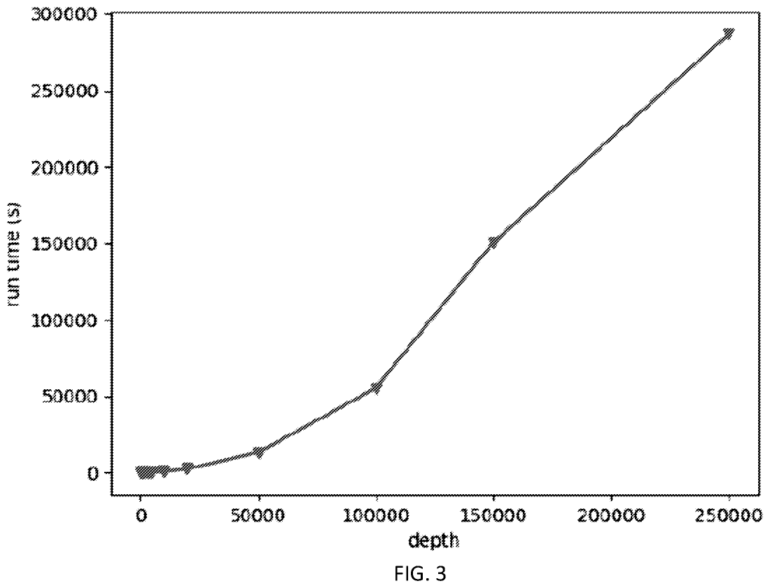

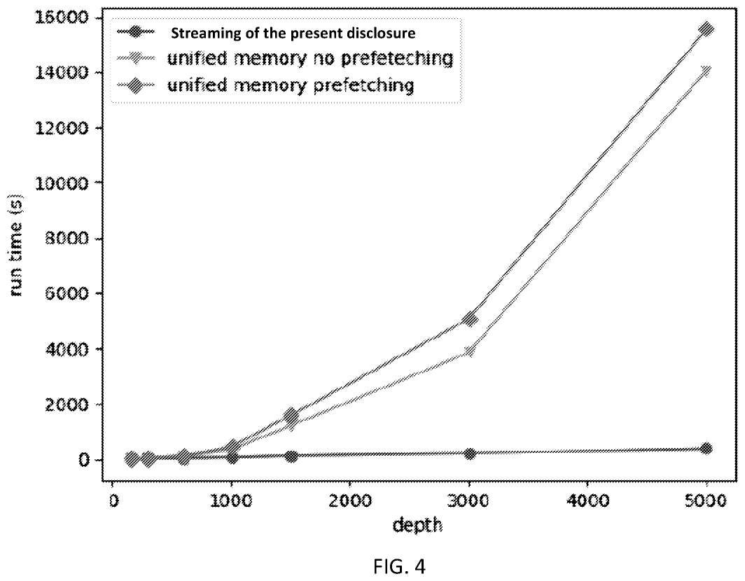

In the instant implementation, RESNET was trained on the ILSVRC 2012 training set for 20 iterations. FIGS. 2a-2b compare run times for carrying out this with the Scorch and PYTORCH implementations of RESNET under various conditions. It should be noted that FIGS. 2a-2b were prepared with checkpointing. However, it should be appreciated that checkpointing without streaming would allow large growth in depth. This growth is because checkpointing reduces the memory growth from linear to logarithmic in network depth. However, streaming without checkpointing would only allow small growth in depth, since streaming only increases the available memory by a constant amount without changing the asymptotic complexity. According to one embodiment, checkpointing and streaming are both carried out because as they are complementary. As stated above, checkpointing reduces the memory needed for activation while steaming reduces the memory needed for weights. Each iteration involves using reverse AD to compute the gradient of a loss function on a batch of 30 images and updating the weights. When n GPUs are used, the batch size is 30n. FIG. 2a compares the run time of the Scorch implementation of RESNET-152, with and without tensor streaming, with the PYTORCH implementation, for various numbers of GPUs. The Scorch run time, without tensor streaming, is generally the same as the PYTORCH run time. Tensor streaming generally reduces the speed by no more than a factor of two. FIG. 2b compares the run time of the Scorch implementation, on a single GPU, with tensor streaming, for various depths and base-case durations. The run time is generally the same for a given depth, as the base-case duration varies, demonstrating that our implementation incurs little overhead in the interruption and resumption mechanism. FIG. 3 compares the run time of the Scorch implementation, on a single GPU, with tensor streaming, for various depths, all with a base-case duration of 10,000. This shows that the implementation of the methodology of the present disclosure can scale to a depth of 250,001. The run time scales slightly super-linearly due to the O(lg T) time penalty of divide-and-conquer checkpointing. The largest previous version of RESNET in the original release has a depth of 1,202; therefore, in this implementation the depth was increased by 200 times. FIG. 4 compares the run times with the implementation of tensor streaming discussed above with an alternate implementation based on NVIDIA's unified memory, both with and without prefetching, where prefetching is used to implement the streaming plan, for the Scorch implementation on a single GPU with a base-case duration of 20,000. The implementation of tensor streaming discussed above vastly outperforms the alternate one based on NVIDIA's unified memory, irrespective of whether prefetching is used or not.

The second application to demonstrate the feasibility of the present methodology is semantic segmentation. While image classification, as performed by RESNET, represents the task of labeling an entire image with a single class, semantic segmentation is the task of labeling each pixel in an image with a class. The current highest-performing system for carrying out semantic segmentation on the MICROSOFT COCO dataset is DRANET. DRANET is based on RESNET, using RESNET as the backbone of an encoder while adding a custom decoder, allowing it to similarly scale to arbitrary depths. The original published version of DRANET had a depth of 101. Here, DRANET is reimplemented in Scorch and variants evaluated with depths of 152, 302, 602, 1,001, 1,502, 3,003, 5,000, 10,001, 20,000, 50,000, 100,001, 150,002, and 250,001. For these experiments, the method of the present disclosure trains DRANET on the CITYSCAPES training set for 20 iterations with a batch size of 4 images per GPU.

The third application to demonstrate the feasibility of the present methodology is GPT-3. Transformers are a deep-learning architecture receiving significant current attention in the natural-language processing community. The largest transformer with publicly available code and pretrained models is GPT-2. While the original implementation of GPT-2 is in TensorFlow, a version rewritten in PYTORCH is available. The developers of GPT-2 have enlarged and enhanced it to yield GPT-3. GPT-3 is currently the largest published transformer model. However, neither the code nor pretrained models are publicly available. The architecture of GPT-2 and GPT-3 are identical, differing only in the choice of various architectural hyperparameters. Similar to RESNET, the GPT architecture is formulated as the repetition of a variety of blocks; changing the amount of repetition can lead to architectures of different depths. The work that introduced GPT-3 evaluated a number of intermediate architectures with depths between that of GPT-2 and that of GPT-3. GPT-3 is the largest known neural-network architecture. With 175 billion parameters, it can only be trained on a large cluster of GPUs (up to 10,000 GPUs). All models were trained on V100 GPUs on part of a high-bandwidth cluster provided by MICROSOFT.

OPENAI trains all of their AI models on the CUDNN-accelerated PYTORCH deep learning framework. MICROSOFT and OPENAI have recently announced a new GPU-accelerated supercomputer built exclusively for the organization. The supercomputer developed for OPENAI is a single system with more than 285,000 CPU cores, 10,000 GPUs and 400 gigabits per second of network connectivity for each GPU server.

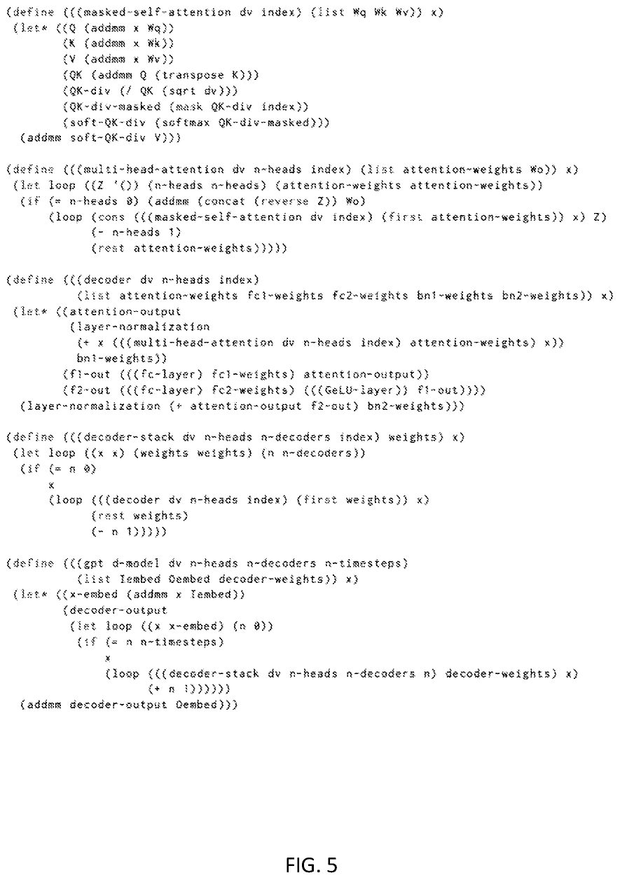

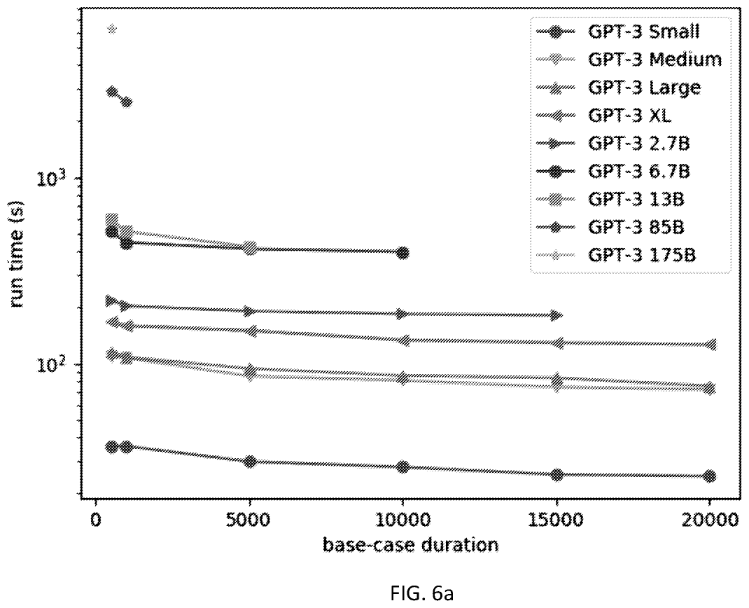

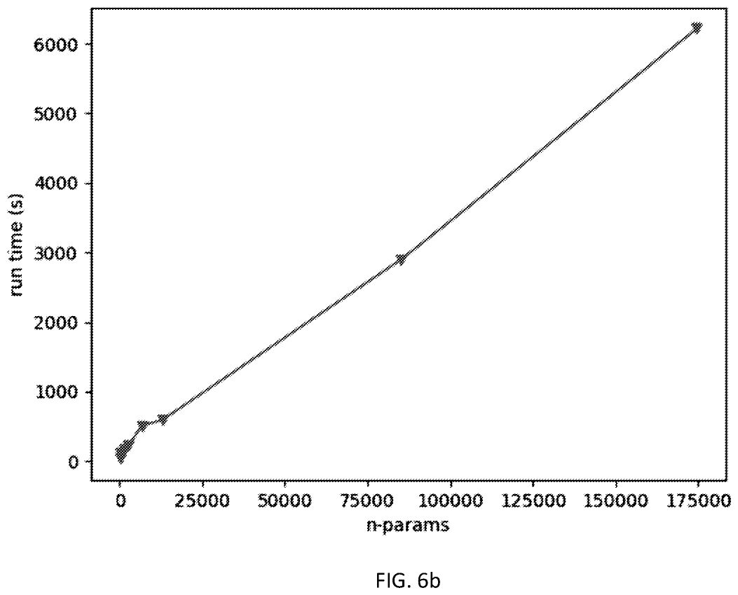

The GPT architecture was implemented in Scorch. The basis of the implementation is shown in FIG. 5. All of the variants of GPT-3 from the original work can be formulated by changing the four hyperparameters d-model, dv, n-heads, and n-decoders. The training set for GPT-3 is not publicly available. For these experiments, all of the variants of GPT-3 were trained from the original published work for 10 iterations on the WMT′14 English-German dataset. Run times are presented in FIGS. 6a and 6b. All runs use a single GPU, with tensor streaming, for 10 iterations, with a batch size of 1,000. The larger models do not run with larger base-case durations because the sizes of the individual layers change in addition to the depth of the model, precluding fitting the larger models in GPU RAM with larger base-case durations. Here again, FIG. 6a shows that the implementation incurs little overhead in the interruption and resumption mechanism. FIG. 6b shows that the implementation according to the present disclosure scales slightly super-linearly with the number of parameters, which is related to network depth.

Prior work has posed tensor migration scheduling as an optimization problem and has developed various approaches to solving it. One prior art work presented a heuristic based on tensor size and the duration of a program interval where that tensor is not accessed to decide which tensors to offload and when. Another prior art work presented a different heuristic, offloading the activations of convolutional layers as they are computed, but not other layers, to the CPU, to fit the GPU RAM budget specified by the user. Yet another prior art work used two different CPU memory pools, each of which had different characteristics, and used integer linear programming to decide which parts of the tape to offload to which of the CPU memory pools. Still yet another prior art work used a genetic algorithm to optimally reorder the sequence of operations to get a better alignment with offloading the tape to the CPU. Others only applied to a primal that could be expressed as a simple sequence of layers. For example, one prior art work presented migration strategies based on the sizes and access frequencies of tensors. Another extended this work to offload some of the computation to the CPU as well. Still another posed migration scheduling as a constraint-satisfaction problem (CSP). Solving this CSP yielded a solution to achieve the desired FLOPs while maintaining a given GPU RAM budget under the PCIe bandwidth constraints. Another used dynamic programming while yet another used mixed integer programming to schedule migration. All this work is only able to offload a part of the tape, not the entire tape, to the CPU, because offloading the entire tape would degrade performance. However, Scorch never offloads the tape to the CPU and thus it doesn't need to solve the associated migration scheduling problem.

The tensor-streaming mechanism according to the present disclosure has three benefits. Since Scorch is a functional language, no mutation can occur, which means that, once used, the tensors copied to the GPU can be evicted and do not need to be copied back to the CPU, so long as the original copy is kept on the CPU. This saves half the communication time incurred by other duplex streaming systems. Since tensor streaming is implemented at the language-implementation level, it can do both pre-planned fetching, by using get-streaming-plan to create a streaming plan in advance, and demand fetching in programs with control flow where a pre-determined order cannot be obtained without running the computation. This allows us to run programs that have control flow, such as the ray tracer example, and not just neural networks.

A memory-pool manager is implemented for the tensor streaming method of the present disclosure instead of using cudaMalloc and cudaFree for allocating individual tensors, because calls to these functions are synchronous and incur non-negligible overhead.

It should be appreciated that while the present disclosure describes interactions with CPUs and GPUs, no such limitation is intended thereby. Specifically, the methodology of the present disclosure can be applied to any sets of processors. For example, the CPU discussed herein should be interpreted as one or more processors belonging to a first class of processors while the GPU should be interpreted as one or more processors belonging to a second class of processors. The second class of processors can be any coprocessor such as a GPU, a tensor processor unit, a math coprocessor, and other coprocessors known to a person having ordinary skill in the art.

Those having ordinary skill in the art will recognize that numerous modifications can be made to the specific implementations described above. The implementations should not be limited to the particular limitations described. Other implementations may be possible.

1. A computer-implemented method of operating on a program, comprising:
executing at least one instruction towards method of operating a program, the execution of the at least one instruction includes:
receiving request for input data associated with at least one dataset;
at run time determining if the input data associated with the at least one dataset is resident on memory of one or more processors of a second class;
if the associated input data is resident on the memory of the at least one or more processors of a second class, i) retrieving only the associated input data from the memory of the at least one or more processors of a second class, ii) using the retrieved input data in the execution of the at last one instruction, and iii) generating output data associated with the at least one dataset;
if not resident on the memory of the at least one or more processors of a second class, determining if the input data associated with the at least one dataset is resident on memory of one or more processors of a first class;
if the associated data is resident on the memory of the at least one or more processors of a first class and not resident on the memory of the at least one or more processors of a second class, i) retrieving only the associated input data from the memory of the at least one or more processors of a first class, ii) copying the associated input data from the memory of the one or more processors of a first class onto the memory of the at least one or more processors of a second class, iii) using the retrieved input data in the execution of the at last one instruction, and iv) generating output data associated with the at least one dataset.

2. The method of claim 1, performing a copying or writing operation to the memory of the one or more processors of a second class, includes:
determining if there is sufficient contiguous memory available in the one or more processors of a second class;
if there is sufficient contiguous memory, performing the copying or writing operation to the memory of the one or more processors of a second class;
if there is not sufficient contiguous memory, calling a garbage collector adapted to remove unneeded data in the memories of the one or more processors of a second class.

3. The method of claim 2, further comprising determining if there is still insufficient contiguous memory in the memories of the one or more processors of a second class, then compacting data in the memories of the one or more processors of a second class.

4. The method of claim 2, further comprising determining if there is still insufficient contiguous memory in the memories of the one or more processors of a second class, then removing least recently used data in the memories of the one or more processors of a second class.

5. The method of claim 2, further comprising determining if there is still insufficient contiguous memory in the memories of the one or more processors of a second class, then halt execution of the at least one instruction and issuing an out-of-memory error.

6. The method of claim 1, further comprising:
initially analyzing the program; and
generating a streaming plan for usage of data associated with the one or more datasets, where the streaming plan includes when input data associated with the at least one datasets is needed.

7. The method of claim 6, wherein the streaming plan is further based on when output data associate with the at least one datasets is available for storage in memory of the at least one or more processors of a second class.

8. The method of claim 6, wherein the step of analyzing the program includes performing a profile run at run time to determine structure the program.

9. The method of claim 8, wherein the program is a functional differential program.

10. The method of claim 9, wherein the functional differential program is a structured network.

11. The method of claim 10, wherein the structured network is a neural network.

12. The method of claim 6, wherein the streaming plan includes pre-fetching data for the memories of one or more processors of a second class based on a window of future cycles of the one or more processors of a second class.

13. The method of claim 12, wherein size of the window is predefined.

14. The method of claim 12, wherein size of the window is provided by a user.

15. The method of claim 12, wherein size of the window is adaptive based on the out-of-memory errors.

16. The method of claim 6, wherein the step of analyzing the program includes performing a static analysis at compiler stage to determine variable control flow of the program.

17. The method of claim 16, wherein the static analysis is adaptive based on a speculative execution scheme.

18. The method of claim 1, wherein the at least one dataset is a tensor.

19. The method of claim 1, wherein the one or more processors of a second class includes coprocessors.

20. The method of claim 19, wherein the coprocessors include graphics processing units.

21. The method of claim 19, wherein the coprocessors include tensor processing units.

22. (canceled)
